(19) United States
(12) Patent Application Publication
(10) Pub. No.: US 2008/0270318 A1
(43) Pub. Date: Oct. 30, 2008

(54) PRODUCT STOCK EXCHANGE

(75) Inventors: Darian L. Wilson, (US); Andrew M. Cefai, Tokyo (JP); Jacob P. Goldblatt, Los Angeles, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: IPO 2.0 LLC, Los Angeles, CA (US)

(21) Appl. No.: 12/107,551

(22) Filed: Apr. 22, 2008

Related U.S. Application Data
(60) Provisional application No. 60/914,683, filed on Apr. 27, 2007.
(60) Provisional application No. 60/992,062, filed on Dec. 3, 2007.

(51) Int. Cl. G06Q 40/00

(52) U.S. Cl. 705/36 R; 705/37

(57) ABSTRACT

Embodiments disclosed herein generally relate to a product trading exchange. In embodiments, the trading exchange trades shares of products and/or product concepts. The shares can be offered first in an initial public offering. After the shares are sold in the IPO, shares are traded in an open trading exchange. In embodiments, the determination of the price for the shares is dynamic and fluctuates with market demand. Revenue earned by the product can also be provided to the share owners according to the percentage of ownership.

### CROSS-REFERENCES TO RELATED APPLICATIONS

This application is related to and claims priority from: co-pending U.S. Provisional Patent Application No. 60/914,683, filed Apr. 27, 2007 and entitled “SYSTEM AND METHOD TO ENCOURAGE AND PROMOTE COMMUNITY-OWNERSHIP OF MUSIC THROUGH THE USE OF A GLOBAL MUSIC STOCK EXCHANGE;” U.S. Provisional Patent Application No. 60/992,062, filed Dec. 3, 2007 and entitled “PRODUCT EXCHANGE SYSTEMS AND METHODS;” and U.S. patent application Ser. No. ______, Attorney Docket No. 026960-000110US, filed concurrently herewith, entitled “PRODUCT EXCHANGE SYSTEMS AND METHODS”. The disclosure of the foregoing applications are hereby incorporated by reference as if set forth in full in this document, for all purposes.

### BACKGROUND OF THE INVENTION

Obtaining money to launch a new product can be difficult. Inventors or small companies have limited options for seed money. For example, the inventors or small companies may obtain bank financing. However, banks are often reluctant to loan money to start-up companies or individual inventors. Further, banks often do not lend enough money. Inventors and start-up companies often turn to angel investment. However, angel investors often desire a percentage of the start-up company. The amount of interest can also be extreme for angel investment. Thus, there are not many sources of financing available for inventors of start-up companies to launch new products and those few sources of financing have several detriments.

It is in view of these and other considerations that the present application is being offered.

### BRIEF SUMMARY OF THE INVENTION

Embodiments presented herein generally relate to a product stock exchange. In embodiments, a product owner can offer one or more shares in a product to one or more purchasers. The purchasers can purchase the shares first in an initial public offer and then from a trading exchange. The share price for the shares may first be determined by the IPO then by market conditions. In embodiments, as the product earns revenue, the revenue is shared with the one or more share owners. As such, the owners derive value from share ownership. Further, the product owner receives money to launch the product.

This Summary only provides a description of some embodiments and is not meant to limit the scope of the invention in any manner or form. The invention is defined only by the claims attached hereto.

### BRIEF DESCRIPTION OF THE DRAWINGS

FIG. 1 is an exemplary web page for a product trading exchange.

FIG. 2A is an exemplary embodiment of a share trade web page.

FIG. 2B is an exemplary embodiment of a purchase/sell trade web page.

FIG. 3 is a block diagram of an embodiment of a global product trading exchange system.

FIG. 4A is a functional block diagram of an embodiment of a user server.

FIG. 4B is a functional block diagram of an embodiment of a share trading component of a user server.

FIG. 5 is a flow diagram of an embodiment of a method for offering an IPO for a product.

FIG. 6 is a flow diagram of an embodiment of a method for trading shares in a product.

FIG. 7 is a flow diagram of an embodiment of a method for determining revenue for shares of a product.

FIG. 8 is a block diagram of an embodiment of a computer system operable to function in the systems described herein.

FIG. 9 is a block diagram of an embodiment of a networked system of computers operable to function in the systems described herein.

### DETAILED DESCRIPTION OF THE INVENTION

Embodiments disclosed herein provide a novel trading system for investing in products or product concepts. In embodiments, a user enters a trading exchange website. The user can select one or more products or product concepts and purchase one or more shares in the product or product concept. The user may later trade the shares or receive value from the sales of the product. In embodiments, the products are digital music files, books, consumer products, movies, etc.

The embodiments described herein allow an inventor, company, or other entity (commonly referred to as the “product owner”) obtain capital for product introduction from selling a portion of ownership in the product. The product owner is the entity that owns the original intellectual property or right to distribute, manufacture, sell, or use the product and can sell an interest or a portion of ownership in the intellectual product of the product. The “product owner” is not to be confused with the consumer that may purchase a product. The revenue derived from the product can be apportioned to the owners commensurate with each owner's share of ownership. The inventor or company need not obtain angel investment, loans, or venture capital to generate money for introducing a product. Thus, the inventor or company may retain a controlling interest in the product and still gather needed capital.

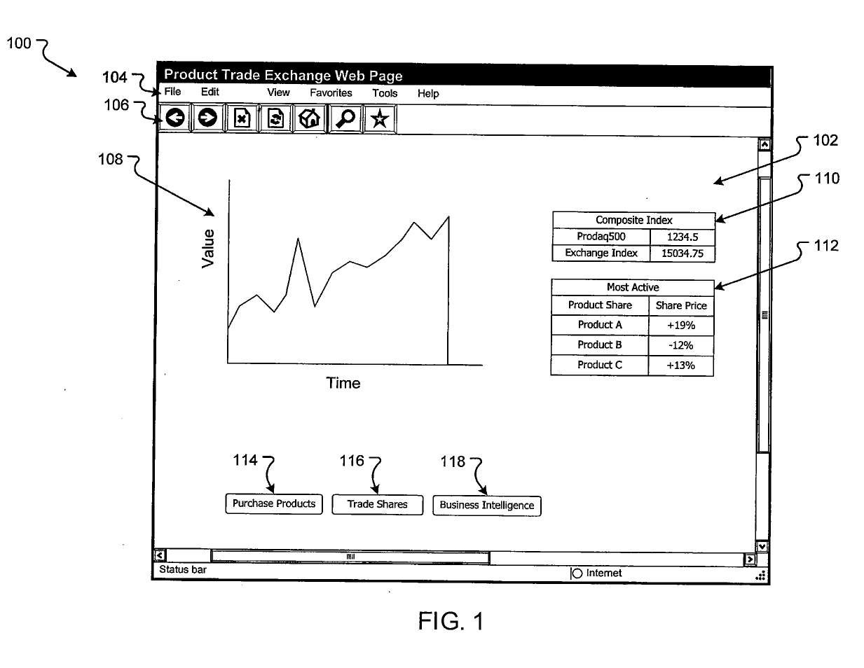

An embodiment of a trading exchange website 102, displayed in a window 100 of a computer user interface, is shown in FIG. 1. In embodiments, the window may include one or more user interface displays or user interface devices. For example, the window 100 includes a menu item bar 104 that includes one or more user interface devices for selecting one or more menus. The window 100 also includes a toolbar 106 having one or more user interface devices for accomplishing one or more actions. The window 100, in embodiments, displays a trading exchange website 102.

The trading exchange website 102 can include one or more displays. For example, the trading exchange website 102 shows a trading exchange index graph 108 that can provide a measure for the value in the trading exchange at a moment in time. The trading exchange website 102 can also provide a trading exchange index 110. The trading exchange index 110, in embodiments, provides a representation of the value in the trading exchange. The trading exchange index 110 may include a value for one or more representative products. In embodiments, the trading exchange index 110 includes a value for only a portion or subset of the products or product concepts being traded. The trading exchange website 102 may also show a list 112 of products or product concepts that are the most active in trading.

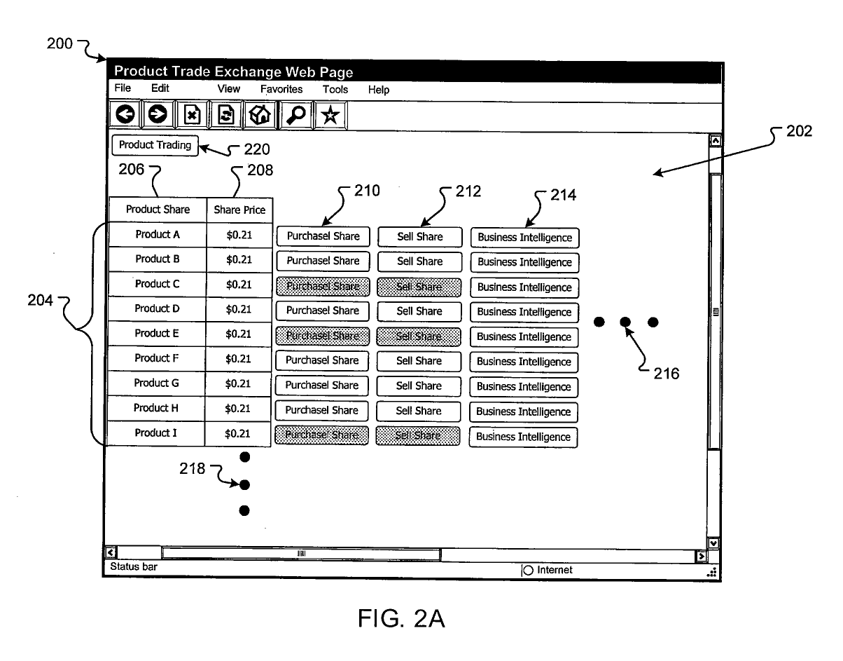

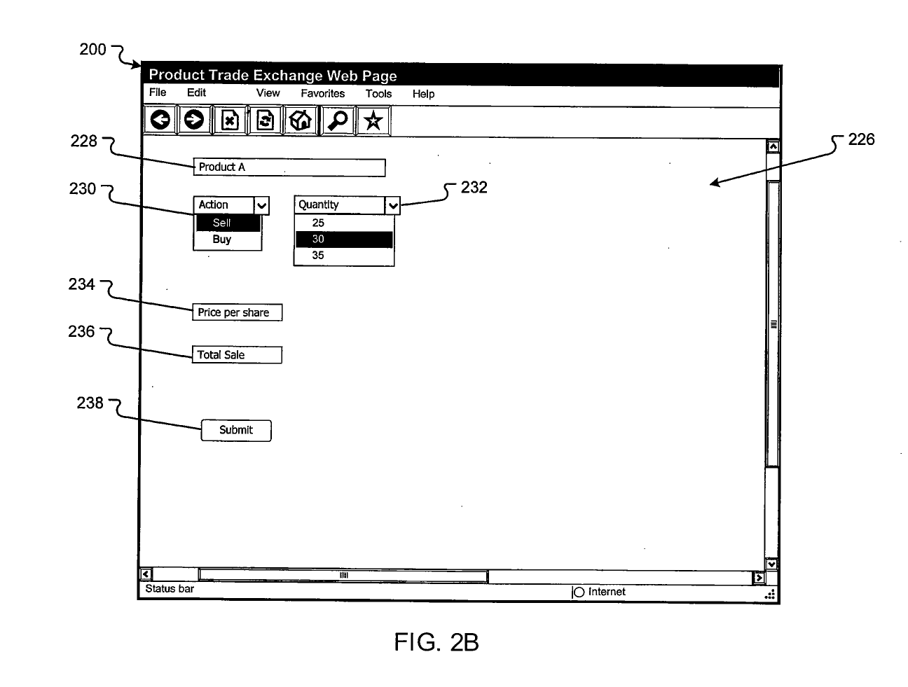

In embodiments, the trading exchange website 102 provides one or more user interface devices that allow a user to accomplish tasks. For example, if the user selects the business intelligence button 118, the user is provided a display of information about one or more products or product concepts. If the user selects the purchase products button 114, the user can be provided with a web page that allows the user to purchase one or more products. In embodiments, the products offered for sale are associated with one or more shares being traded on the trading exchange website 102. If the user selects the trade shares button 116, the user can purchase or sell one or more shares for one or more products or product concepts being traded on the trading exchange website 102. If the user selects the trade shares button 116, the user may be provided a web page 202 as described in conjunction with FIG. 2A.

An embodiment of a user interface window 200 displaying a trading web page 202 is shown in FIG. 2A. In embodiments, the trading web page 202 allows the user to interact with one or more other share owners to purchase or sell shares in one or more products or product concepts. The trading web page 202, in embodiments, provides one or more displays or user interface devices that allow for trading of shares. There may be more or fewer user interface devices as represented by ellipses 216. For example, the trading web page 202 displays a list 204 of one or more products or product concepts available for trading. The list 204 may have more or fewer products than those shown in FIG. 2 as represented by the ellipses 218. In embodiments, the list 204 includes elements for the name of the product share 206 and the price per share 208 for the product.

In embodiments, the user may also be able to select a business intelligence button 214 to be provided information about the product displayed in the list 204. Business intelligence may include information about the product (e.g., product price, product revenue, manufacturer, description, etc.), about the owner or entity offering the product, the entity selling the shares (e.g., rating of the seller or buyer, negative comments about the seller or buyer, information on purchasing the share from or selling the share to this owner, etc.), etc.

To trade the shares, the user, in embodiments, selects a purchase share button 210 or a sell share button 212. The user may then receive a trade web page 226, as shown in FIG. 2B. The product share being traded may be displayed or entered into user interface device 228. In embodiments, a user selects the number of shares to be purchased or sold with a user interface device 232. The user can select whether they are buying or selling shares with user interface device 230. A price per share may be determined and displayed in display 234. The cost of the transaction (the number of shares selected multiplied by the price per share) is, in embodiments, displayed in display 236. The user can complete the transaction by selecting the submit button 238. After a user purchases shares, the user becomes a shareholder.

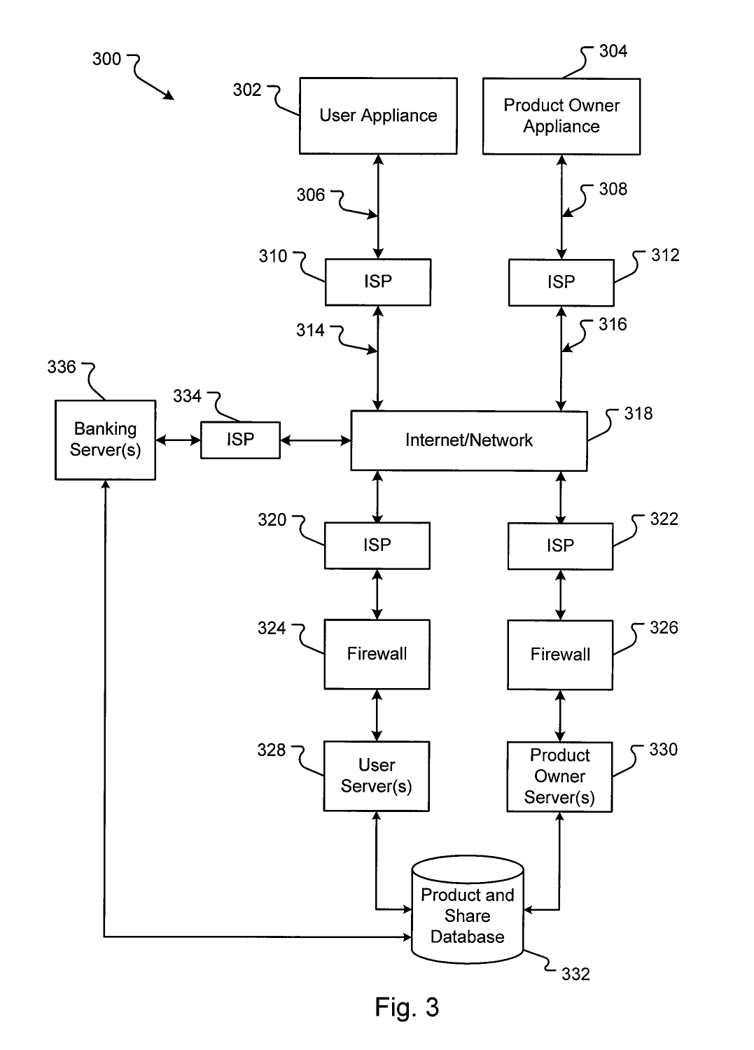

An embodiment of a product trading exchange system 300 is shown in FIG. 3. The product trading exchange system 300, in embodiments, allows one or more product owners to offer ownership shares in the product or product concept and allows users to purchase and trade the shares in the product. In embodiments, the system 300 comprises a banking server 336, one or more product owner servers 330, and/or one or more user servers 328. The components of the system 300 communicate with each other through a network 318 and one or more information appliances (for example, user appliance 302, product owner appliance 304, internet service providers 310, 312, 320, 322, and/or 334, and firewalls 324 and/or 326).

It should be noted that the arrangement of the system 300 in FIG. 3 is intended to be exemplary in nature, and that other arrangements are possible in accordance with various embodiments. Similarly, while the description below ascribes certain functionality to various components of the system 300, it should be appreciated that, in other embodiments, such functionality could be provided by different components. Merely by way of example, the collective functionality ascribed to two or more components could be incorporated within a single component; similarly, the functionality ascribed to a single component could be divided among multiple components.

The individual client information appliances 302 and/or 304 can include, without limitation, PCs, wireless devices, etc., capable of communicating with a server. Information appliances 302 and/or 304 can access a service provider, such as an Internet Service Provider (ISP) 310, either directly or via a network connection 314 and/or 316. In general, the system 300 may be used in conjunction with any suitable information appliance device 302 and/or 304 that is capable of communicating with other components of a communications network, such as a network server, and which include the necessary interfaces for inputting information, viewing presented information, and selecting and otherwise manipulating presented information.

As described above, client information appliances 302 and/or 304 may be, for example, commercially available general purpose computer hardware such as personal computers, equipped with a desktop browser that enables the user to access the Internet. Each client information appliance 302 and/or 304, in embodiments, has an associated communications link 306 and/or 308, respectively, to connect the client information appliance to a service provider, such as an Internet Service Provider (ISP) 310 and/or 312. In FIG. 3, each client information appliance 302 and/or 304 is shown as being connected to a unique ISP 310 and/or 312. It should be noted that multiple user client information appliances 302 may be connected to the same ISP 310 and multiple product owner client information appliances 304 may be connected to the same ISP 312. Additionally, ISPs 310 and/or 312 may be the same service providers. In embodiments, communications links 306 and/or 308 connect the ISP 310 and/or 312 to the network 318. Each client information appliance 302 and/or 304 can transmit and receive data from the network 318 through its ISP 310 and/or 312.

Network 318 is any network of inter-connected information appliance devices. In embodiments, network 318 is a local area network (LAN), wide area network (WAN), or the Internet. The network 318, in embodiments, is the Internet with World-Wide-Web capabilities, allowing access to information and services by using hypertext to organize, search and present information to users.

From a hardware standpoint, in one embodiment, servers 336, 328 and/or 330 will typically contain one or more components, such as one or more microprocessors, for performing the operations required for program operation. A server computer 336, 328 and/or 330 may also typically contain disk storage media, such as one or more disk drives for program and data storage, and a random access memory, for temporary data and program instructions. The servers 336, 328 and/or 330 can be a single server computer system or two or more server computer systems operating in conjunction to perform the operations described herein. In embodiments, the servers 336, 328 and/or 330 are connected to the Internet 318 via one or more ISPs 334, 320, and/or 322, respectively.

In embodiments, servers 336, 328 and/or 330 are connected to a database 332. The database 332 may be one or more storage devices operable to store data. For example, the database 332 is a disc storage array. The storage media may be controlled or managed by a database management system. In one embodiment, the database is a relational database. One or more items of data about products offered for sale, about shares sold or owned, and/or other business intelligence is stored on the database 332. The servers 336, 328 and/or 330 can communicate with the database to store or access the information. The database can be used to create user accounts storing information about shares owned, value of the shares, projected revenue, etc.

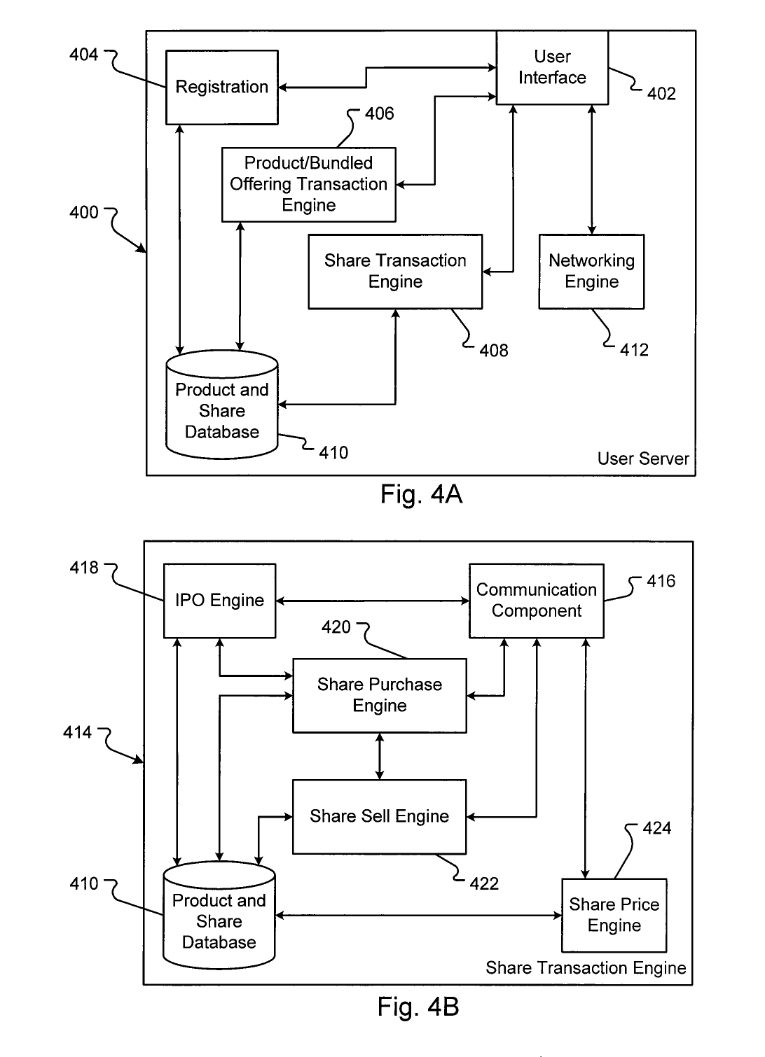

An embodiment of a user server 400 is shown in FIG. 4A. In embodiments, the user server 400 is the same or similar to user server 328 (FIG. 3). The user server 400 may comprise one or more components. The components, in embodiments, are one or more software components having instructions to execute one or more computer-executable methods described herein. The software may be resident on the disc media storage, which, when executed, directs the server to perform their data transmission and reception functions. In embodiments, the user server 400 comprises a registration component 404, a product/bundled offering transaction engine 406, a share transaction engine 408, a networking engine 412, and/or a user interface 402. A product and share database 410, similar or the same as product and share database 332 (FIG. 3), may also be a part of the user server 400 but may also be a separate device accessible by the user server 400.

The user server 400 software allows a user appliance 302 (FIG. 3) to interface with the global network-based trading exchange platform 300 (FIG. 3) through the user interface 402. The user interface 402 can provide one or more web pages that are rendered by the user appliance 302 (FIG. 3). The user, in embodiments, trades shares, gathers business intelligence, and completes other activities through the web pages created by the user interface 402.

A registration component 404, in embodiments, allows a user to register with the network-based trading exchange to trade shares, gather business intelligence, and complete other activities. To register, a user inputs information into the registration component 404, for example, name, address, email, and username. The registration component 404 may then store the information in the product and share database 410. In alternative embodiments, the registration component 404 also receives the acceptance from the user of the revenue share agreement for buying and trading shares of the product.

A product/bundled offering transaction engine 406 may provide for the purchase of products. In embodiments, the product/bundled offering transaction engine 406 reads information about one or more products, and possibly, one or more revenue share agreements, from the product and share database 410. The information about the products and revenue share agreements is provided to the user interface 402 to present to the user. The user may purchase the product from the product/bundled offering transaction engine 406. The product/bundled offering transaction engine 406 may then send or allow the user to download the product from the product and share database 410. In alternative embodiments, the product/bundled offering transaction engine 406 also provides the shares to the user.

In embodiments, a share transaction engine 408 provides a system to buy and sell shares in the products the user has purchased. The trading of shares may be based on the terms and conditions of the revenue share agreement. In embodiments, the share transaction engine 408 can provide a system to the user interface 402 to present one or more web pages where the user can trade shares. The share transaction engine 408 can read information about share price, volume, and other information from the product and share database 410. Further, the share transaction engine 408 can store information to the product and share database 410.

Software in the share transaction engine 408, in embodiments, allows the user to continue to buy and sell shares, match bids on a priority basis, store bids in a priority queue, report final sales of a particular transaction, execute buy and sell orders of a share for which the bid and offer have been matched and approved, confirm the execution of an approved trade to both buyers and sellers for bids and offers that are matched, and create and manage user accounts. The share transaction engine 408 may also detect, with a compliance system (not shown), unauthorized trades of the product and disbar those users from performing the unauthorized trades of the products. In embodiments, the share transaction engine 408 transmits details of the above transactions to the user's information appliances 302 (FIG. 3) via network 318 (FIG. 3) and associated communication links.

A networking engine 412, in embodiments, allows a user to engage in social networking services. For example, a user may communicate with the user server 400 to create a personalized homepage, to write a blog, to upload photos, and/or to participate in an affiliate program. In embodiments, the user can communicate with other music share traders using a communication system offered by the networking engine 412. For example, the networking engine 412 provides an email system, a blog, and/or an instant messaging system.

In embodiments, the networking engine 412 provides a customer loyalty program. The user can be provided an identifier, e.g., a loyalty customer number, which may be listed on a loyalty card or other media. When the user purchases a product or share, the user may enter his or her loyalty identifier. The networking engine 412, in embodiments, assigns some value to the account associated with the identifier. The value may be monetary or some other form of value. For example, the networking engine 412 assigns a predetermined number of loyalty points to the customer's loyalty account having the identifier. The networking engine 412 may include an account for the customer in the product and share database 410 and store the value information in the product and share database 410. After reaching some predetermined threshold, the customer may use the points or value to obtain a product, a share, or some other reward.

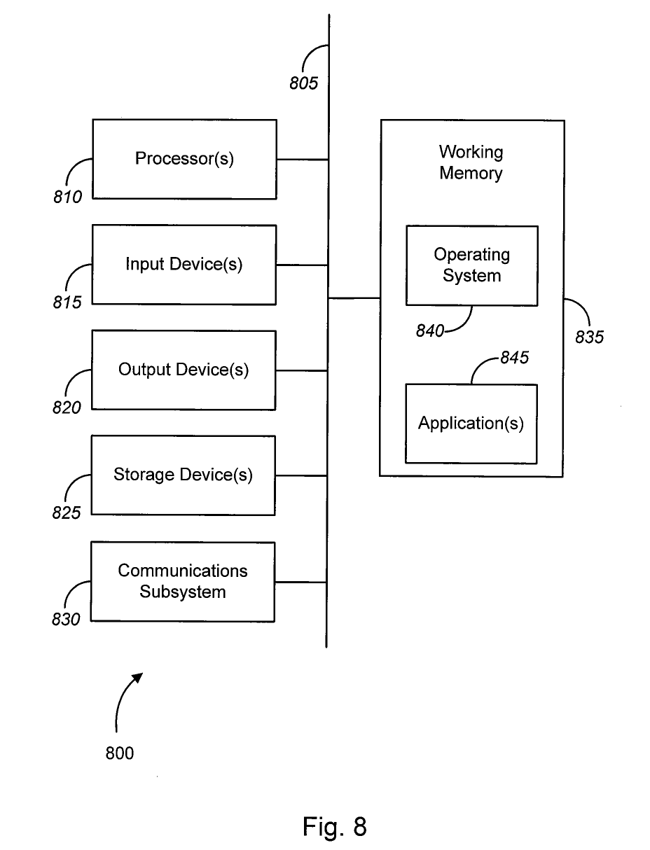

An embodiment of a share transaction engine 414 is shown in FIG. 4B. The share transaction engine 414 may be the same or similar to share transaction engine 408 (FIG. 4A). In embodiments, the share transaction engine 414 comprises one or more components, which may be software, hardware, or a combination of both hardware and software. The share transaction engine 414, in embodiments, comprises an initial public offering (IPO) engine 418, a communication component 416, a share purchase engine 420, a share sell engine 422, and/or a share price engine 424. A product and share database 410 may be a shared database that is either part of the share transaction engine 414 or a separate component interfaced with the share transaction engine 414. In embodiments, the product and share database 410 is the same or similar to the product and share database 332 (FIG. 3). The communication component 416, in embodiments, communicates with the user appliance 302 (FIG. 3) to receive information, for example, number of shares to be purchased, price to be paid, etc., or to send information, for example, share price for shares, number of shares being offered for sale, etc. The communication component 416 can communicate in any form or protocol, for example, TCP/IP, HTML, HTTP, etc., as is explained in conjunction with FIG. 8.

The IPO engine 418, in embodiments, allows an owner of the product or product concept to initially sell shares in the product or product concept. In embodiments, the product owner interfaces with the communication component 416 to communicate a number of shares to provide for the IPO. The product owner can also provide an initial share price for the IPO shares. In embodiments, the IPO engine 418 sells IPO shares until all IPO shares are sold. After all IPO shares are sold, the IPO engine 418 can issue an indication to the share purchase engine 420 and the share sell engine 422 can begin trading shares according to market demand. As such, shares are traded, in embodiments, only after all IPO shares are sold. In embodiments, the IPO engine 418 stores information about the IPO in the product and share database 410. The IPO engine 418 may also receive information about the product for business intelligence.

A share purchase engine 420, in embodiments, allows a user to purchase shares. The share purchase engine 420 can create information for the communication component 416 to generate a trade web page 226 (FIG. 2) for the user. The share purchase engine 420, in embodiments, accepts inputs from the user for purchasing shares. The share purchase engine 420 can record ownership in the product and share database 410 and/or send a purchase confirmation to the user acknowledging the purchase. In embodiments, the share purchase engine 420 provides a share certificate, either electronically or by mail, to the user. The share purchase engine 420 can communicate purchase requests to the share sell engine 422 to match purchase requests with sale offers.

The share sell engine 422 can allow a user to sell one or more shares. The share sell engine 422, in embodiments, interfaces with the communication component 416 to generate a trade web page 226 (FIG. 2) for the user. The share sell engine 422 can also accept inputs from the user for selling shares. The share sell engine 422 stores ownership information in the product and share database 410 and/or send a sell confirmation to the user acknowledging the sale. The share sell engine 422 can communicate sales offers to the share purchase engine 420 to match purchase requests with sale offers.

A share price engine 424 can calculate share prices for sales and purchases according to activity on the exchange. In embodiments, the share price engine 424 accesses data from the product and share database 410 to determine the share price for one or more shares associated with one or more products or product concepts. The share price engine 424 may read and execute a formula from the product and share database 410 to determine share price. For example, as one or more shares are sold for a product, the share price engine 424 accesses one or more prices for the shares and averages the prices over the number of shares listed in the product and share database 410. In other embodiments, the share price engine 424 determines the highest price paid during a predetermined time, e.g., a day, an hour, etc., for a share and associates the highest price for the share price. In still another embodiment, the share price engine 424 associates the last price offered for a share as the share price. The share price engine 424 can access the product and share database 410 periodically to determine the share price. For example, the share price engine 424 accesses the product and share database 410 every hour to determine the share price of each set of shares associated for with each product listed in the product and share database 410.

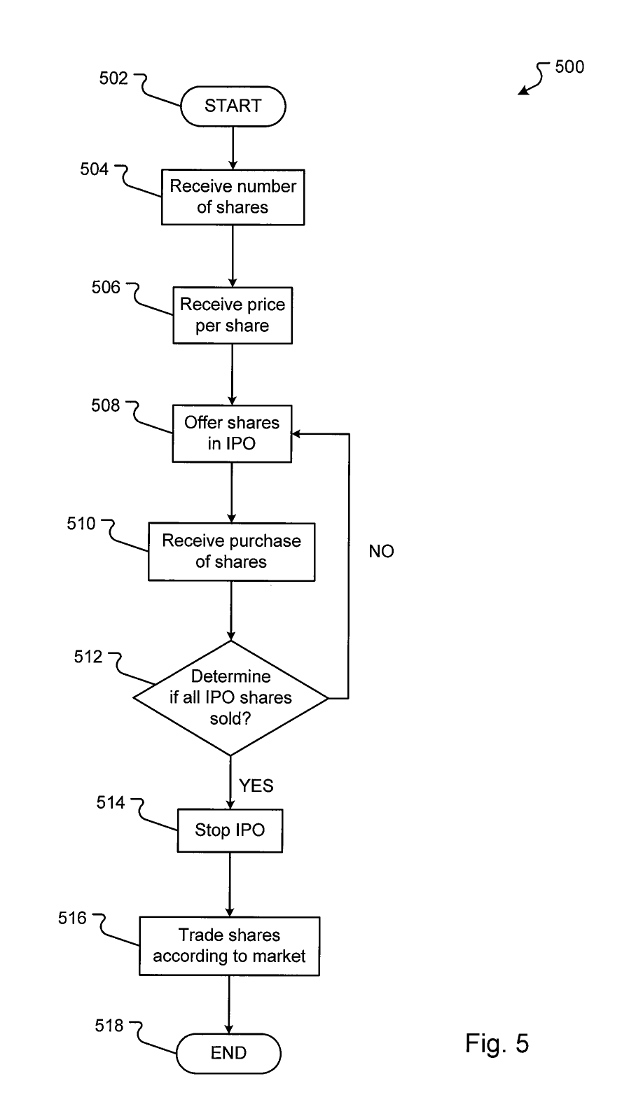

An embodiment of a method 500 for issuing an IPO for one or more shares of a product or product concept is shown in FIG. 5. The method 500, in embodiments, represents one or more instructions executable in a computer system for directing the computer system to complete an action. The instructions may be stored on a storage medium and retrieved by the computer system. The method 500, in embodiments, begins with a start operation 502 and terminates with an end operation 518. While a specific order is shown in FIG. 5, the steps may be performed in a different order.

Receive operation 504 receives the number of shares. In embodiments, a product owner sends a number of shares to be offered in the IPO. The product owner can use the product owner appliance 304 (FIG. 3) to provide the product owner server 330 (FIG. 3) with the number of shares to be offered. In embodiments, the product owner also provides information about the product and the IPO for business intelligence. The IPO engine 418 (FIG. 4B) receives the information about number of shares and stores the information into the product and share database 410 (FIG. 4B).

Receive operation 506 receives the share price for the shares being offered in the IPO. In embodiments, a product owner sends the share price. The product owner can use the product owner appliance 304 (FIG. 3) to provide the product owner server 330 (FIG. 3) with the share price. The IPO engine 418 (FIG. 4B) receives the share price and stores the share price into the product and share database 410 (FIG. 4B).

Offer operation 508 offers the shares for sale. In embodiments, the IPO engine 418 (FIG. 4B) sends information to the share purchase engine 420 (FIG. 4B) to begin selling the shares. The share purchase engine 420 (FIG. 4B) can create information for a trading exchange web page 202 (FIG. 2A) and communicate the information to the communication component 416 (FIG. 4B). The communication component 416 (FIG. 4B), in embodiments, sends the web page 202 (FIG. 2A) to a user appliance 302 (FIG. 3) when requested. The user appliance 302 (FIG. 3) can render the information about the IPO to the user.

Receive operation 510 receives a purchase offer. In embodiments the user uses the user appliance 302 (FIG. 3) to send a purchase request to the user server 328 (FIG. 3). The user can select a purchase button 210 (FIG. 2A) on the trading web page 202 (FIG. 2A) to purchase one or more IPO shares. The share purchase engine 420 (FIG. 4B), in embodiments, generates information for the purchase web page 226 (FIG. 2B) and send the information to the communication component 416 (FIG. 4B). The communication component 416 (FIG. 4B) can generate the purchase web page 226 (FIG. 2B) for the user appliance 302 (FIG. 3) to render to the user. The user can enter a number of shares to purchase and submit the request for the purchase with the purchase web page 226 (FIG. 2B). The share purchase engine 420 (FIG. 4B) can store the purchase information in the product and share database 410 (FIGS. 4A and 4B) and/or send a sale certificate of confirmation to the user appliance 302 (FIG. 3).

Determine operation 512 determines if all IPO shares have been sold. In embodiments, the IPO engine 418 (FIG. 4) determines if the IPO shares have been sold. For example, after each purchase of an IPO share, the IPO engine 418 (FIG. 4) determines the total number of IPO shares that have been sold for all purchases of the IPO shares. If the total number of shares is equal to the number of IPO shares offered by the product owner, all IPO shares have been sold. The IPO engine 418 (FIG. 4), in alternative embodiments, check the number of IPO shares sold periodically, for example, once a day. If all of the IPO shares have been sold, the method 500 flows YES to stop operation 514. If all of the IPO shares have not been sold, the method 500 flows NO back to offer operation 508.

Stop operation 514 stops the IPO. In embodiments, the IPO engine 418 (FIG. 4) sends a signal to the share purchase engine 420 (FIG. 4) to stop selling the shares of the product as an IPO offering. The share purchase engine 420 (FIG. 4) can then determine a market price for the shares, which may be different or the same as the IPO share price. In further embodiments, the IPO engine 418 (FIG. 4) sends a signal to the share sell engine 422 (FIG. 4) to allow users to offer his or her shares for sale.

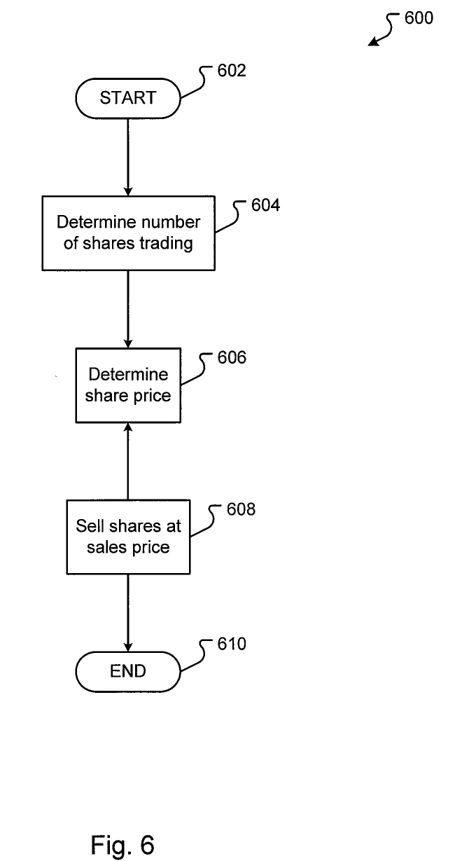

Trade operation 516 trades shares according to the market environment. The share purchase engine 420 (FIG. 4), in embodiments, receives offers and trades shares according to the market share price. In embodiments, the share sell engine 422 (FIG. 4) receives offers to sell one or more shares of the product involved in the IPO from one or more users. The trading of shares on the market is as described in conjunction with FIG. 6.

An embodiment of a method 600 for trading shares of a product or product concept is shown in FIG. 6. The method 600, in embodiments, represents one or more instructions executable in a computer system for directing the computer system to complete an action. The instructions may be stored on a storage medium and retrieved by the computer system. The method 600, in embodiments, begins with a start operation 602 and terminates with an end operation 610. While a specific order is shown in FIG. 6, the steps may be performed in a different order.

Determine operation 604 determines the number of shares trading. In embodiments, the share sell engine 422 (FIG. 4B) determines the number of shares trading. For example, one or more share offerings may have been made for a product. The share sell engine 422 (FIG. 4B) can access the product and share database 410 (FIGS. 4A and 4B) to determine the number of shares trading for a product. The number of shares trading can be provided as business intelligence to a user on the user's appliance 302 (FIG. 3).

Determine operation 606 determines the share price. The share price engine 424 (FIG. 4B), in embodiments, determines the current share price for one or more shares based on trading exchange activity. The share price engine 424 (FIG. 4B) can use one of several methods for determining the share price. For example, the current share price may be the most recent offer price for a share as stored in the product and share database 410 (FIGS. 4A and 4B) and retrieved by the share price engine 424 (FIG. 4B). In other embodiments, the share price engine 424 (FIG. 4B) determines a value for the product and divides the value by the number of shares as determined by the share sell engine 422 (FIG. 4B) and stored in the product and share database 410 (FIGS. 4A and 4B). In other embodiments, the share price is the average offer price provided over a predetermined period of time, e.g., a day, a week, etc. In still other embodiments, the share price is the offer price provided by the seller.

Sell operation 608 sells shares at the share price. In embodiments, the share sell engine 422 (FIG. 4) offers one or more shares for sale. In embodiments, one or more users makes an offer to sell shares using the trade exchange web page 202 (FIG. 2A). In embodiments, the user selects the product shares owned and selects a sell share button 212 (FIG. 2A). A sell share web page 226 (FIG. 2B) can then be provided. The user can enter the product share 228 (FIG. 2B) to sell and the quantity 232 (FIG. 2B) of shares to sell. In embodiments, the user provides the sales price 234 (FIG. 2B). In other embodiments, the share price engine 424 (FIG. 4B) enters the current share price into the sell share web page 226 (FIG. 2B). The user can then select the submit button 238 (FIG. 2B) to complete the sale.

The offer for sale can be accepted by another user using another user appliance 302 (FIG. 3). In embodiments, another user is provided information on a trade exchange web page 202 (FIG. 2A) that shares for the product have been offered for sale. In embodiments, the user selects a purchase share button 210 (FIG. 2A). A purchase share web page 226 (FIG. 2B) can be provided. The user can enter the product share 228 (FIG. 2B) to purchase and the quantity 232 (FIG. 2B) of shares to purchase. In embodiments, the user is provided the sales price 234 (FIG. 2B). The user can then select the submit button 238 (FIG. 2B) to complete the purchase. The request to purchase, in embodiments, is sent from the share purchase engine 420 (FIG. 4B) to the share sell engine 422 (FIG. 4B). The share sell engine 422 (FIG. 4B) can associate the request with an offer for sale or complete the transaction.

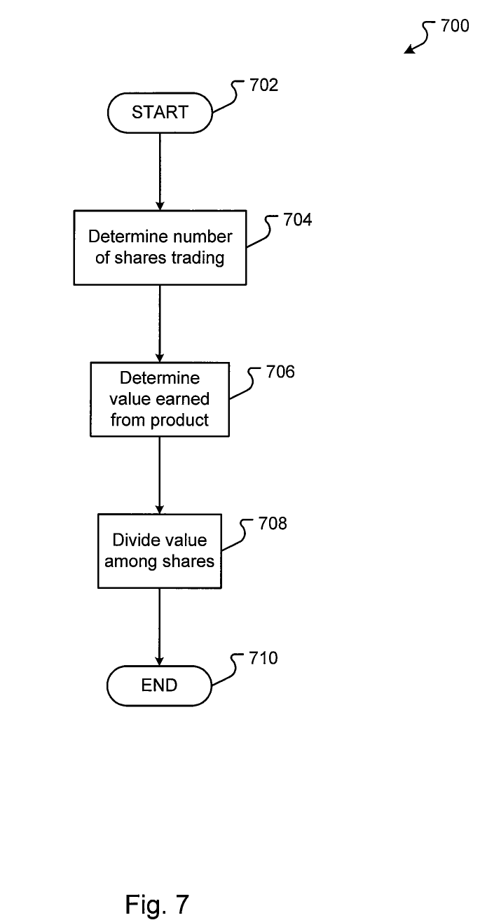

An embodiment of a method 700 for sharing revenue of a product or product concept is shown in FIG. 7. The method 700, in embodiments, represents one or more instructions executable in a computer system for directing the computer system to complete an action. The instructions may be stored on a storage medium and retrieved by the computer system. The method 700, in embodiments, begins with a start operation 702 and terminates with an end operation 710. While a specific order is shown in FIG. 7, the steps may be performed in a different order.

Determine operation 704 determines the number of shares being traded. In embodiments, the share sell engine 422 (FIG. 4) determines the number of shares trading. For example, one or more share offerings may have been made for a product. The share sell engine 422 (FIG. 4) can access the product and share database 410 (FIGS. 4A and 4B) to determine the number of shares trading for a product. The number of shares trading can be provided as business intelligence to a user on the user's appliance 302 (FIG. 3).

Determine operation 706 determines the value earned for the product. A royalty reporting organization can be an outside organization that reports and provides the royalty revenue to the banking and billing sever 336 (FIG. 3). The share sell engine 422 (FIG. 4B) receives information from one or more organizations about the amount of revenue generated from product sales. For example, if the product is a song or album, a royalty reporting organization receives the royalties from one or more sources, for example, online sales, CD purchases from music stores, radio play, etc. The royalty revenue is reported to the share sell engine 422 (FIG. 4B). The revenue comprises the value earned by the product.

Divide operation 708 divides the value among the shares. In embodiments, the share sell engine 422 (FIG. 4B) divides the revenue by the number of shares owned. This amount of money represents the percentage of the revenue associated with each share. For each owner, the share sell engine 422 (FIG. 4B) can multiple the revenue per share by the number of shares owned. This amount is the amount of revenue owed to each owner. The share sell engine 422 (FIG. 4B) can report this amount to the banking and billing sever 336 (FIG. 3), which can send the revenue to the owner. The share sell engine 422 (FIG. 4B) and/or the banking and billing server 336 (FIG. 3) can provide information about revenue as business intelligence in a business intelligence report.

FIG. 8 provides a schematic illustration of one embodiment of a computer system 800 that can perform the methods of the invention, as described herein, and/or can function as a client information appliance, a server, and/or the like. It should be noted that FIG. 8 is meant only to provide a generalized illustration of various components, any or all of which may be utilized as appropriate. FIG. 8, therefore, broadly illustrates how individual system elements may be implemented in a relatively separated or relatively more integrated manner.

The computer system 800 is shown comprising hardware elements that can be electrically coupled via a bus 805 (or may otherwise be in communication, as appropriate). The hardware elements can include one or more processors 810, including without limitation one or more general-purpose processors and/or one or more special-purpose processors (such as digital signal processing chips, graphics acceleration chips, and/or the like); one or more input devices 815, which can include without limitation a mouse, a keyboard and/or the like; and one or more output devices 820, which can include without limitation a display device, a printer and/or the like.

The computer system 800 may further include (and/or be in communication with) one or more storage devices 825, which can comprise, without limitation, local and/or network accessible storage and/or can include, without limitation, a disk drive, a drive array, an optical storage device, solid-state storage device such as a random access memory (“RAM”) and/or a read-only memory (“ROM”), which can be programmable, flash-updateable and/or the like. The computer system 800 might also include a communications subsystem 830, which can include without limitation a modem, a network card (wireless or wired), an infra-red communication device, a wireless communication device and/or chipset (such as a Bluetooth™ device, an 802.11 device, a WiFi™ device, a WiMax device, cellular communication facilities, etc.), and/or the like. The communications subsystem 830 may permit data to be exchanged with a network (such as the network described below, to name one example), and/or any other devices described herein. In many embodiments, the computer system 800 will further comprise a working memory 835, which can include a RAM or ROM device, as described above.

The computer system 800 also can comprise software elements, shown as being currently located within the working memory 835, including an operating system 840 and/or other code, such as one or more application programs 845, which may comprise computer programs of the invention, and/or may be designed to implement methods of the invention and/or configure systems of the invention, as described herein. Merely by way of example, one or more procedures described with respect to the method(s) discussed above might be implemented as code and/or instructions executable by a computer (and/or a processor within a computer). A set of these instructions and/or code might be stored on a computer-readable storage medium, such as the storage device(s) 825 described above. In some cases, the storage medium might be incorporated within a computer system, such as the system 800. In other embodiments, the storage medium might be separate from a computer system (i.e., a removable medium, such as a compact disc, etc.), and/or provided in an installation package, such that the storage medium can be used to program a general purpose computer with the instructions/code stored thereon. These instructions might take the form of executable code, which is executable by the computer system 800 and/or might take the form of source and/or installable code, which, upon compilation and/or installation on the computer system 800 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

In one aspect, the invention employs a computer system (such as the computer system 800) to perform methods described herein. According to a set of embodiments, some or all of the procedures of such methods are performed by the computer system 800 in response to processor 810 executing one or more sequences of one or more instructions (which might be incorporated into the operating system 840 and/or other code, such as an application program 845) contained in the working memory 835. Such instructions may be read into the working memory 835 from another machine-readable medium, such as one or more of the storage device(s) 825. Merely by way of example, execution of the sequences of instructions contained in the working memory 835 might cause the processor(s) 810 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 800, various machine-readable media might be involved in providing instructions/code to processor(s) 810 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media includes, for example, optical or magnetic disks, such as the storage device(s) 825. Volatile media includes, without limitation, dynamic memory, such as the working memory 835. Transmission media includes coaxial cables, copper wire and fiber optics, including the wires that comprise the bus 805, as well as the various components of the communications subsystem 830 (and/or the media by which the communications subsystem 830 provides communication with other devices). Hence, transmission media can also take the form of waves (including without limitation radio, acoustic and/or light waves, such as those generated during radio-wave and infra-red data communications).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, any other memory chip or cartridge, a carrier wave as described hereinafter, or any other medium from which a computer can read instructions and/or code.

Various forms of machine-readable media may be involved in carrying one or more sequences of one or more instructions to the processor(s) 810 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 800. These signals, which might be in the form of electromagnetic signals, acoustic signals, optical signals and/or the like, are all examples of carrier waves on which instructions can be encoded, in accordance with various embodiments of the invention.

The communications subsystem 830 (and/or components thereof) generally will receive the signals, and the bus 805 then might carry the signals (and/or the data, instructions, etc. carried by the signals) to the working memory 835, from which the processor(s) 810 retrieves and executes the instructions. The instructions received by the working memory 835 may optionally be stored on a storage device 825 either before or after execution by the processor(s) 810.

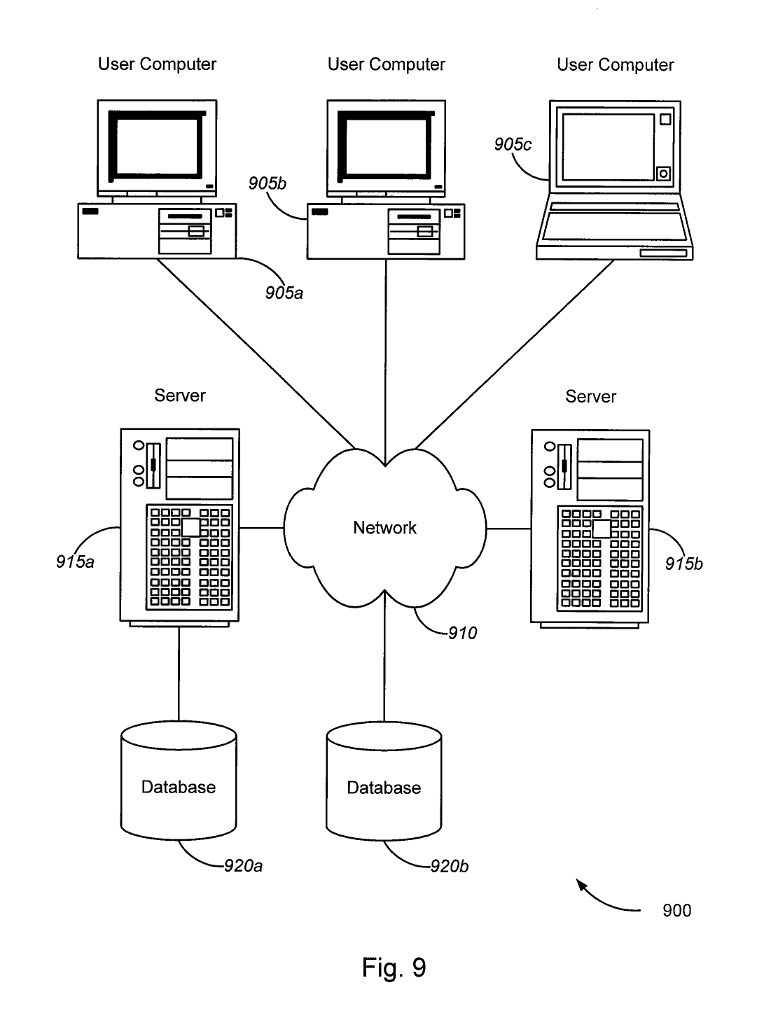

As described above, a set of embodiments comprises systems for online trading. Merely by way of example, FIG. 9 illustrates a schematic diagram of a system 900 that can be used in accordance with one set of embodiments. The system 900 can include one or more user computers 905. The user computers 905 can be general purpose personal computers (including, merely by way of example, personal computers and/or laptop computers running any appropriate flavor of Microsoft® Corp.'s Windows™ and/or Apple Corp.'s Macintosh™ operating systems) and/or workstation computers running any of a variety of commercially-available UNIX™ or UNIX-like operating systems. These user computers 905 can also have any of a variety of applications, including one or more applications configured to perform methods of the invention, as well as one or more office applications, database client and/or server applications, and web browser applications. Alternatively, the user computers 905 can be any other electronic device, such as a thin-client computer, Internet-enabled mobile telephone, and/or personal digital assistant, capable of communicating via a network (e.g., the network 910 described below) and/or displaying and navigating web pages or other types of electronic documents. Although the exemplary system 900 is shown with three user computers 905, any number of user computers can be supported.

Certain embodiments of the invention operate in a networked environment, which can include a network 910. The network 910 can be any type of network familiar to those skilled in the art that can support data communications using any of a variety of commercially-available protocols, including without limitation TCP/IP, SNA, IPX, AppleTalk™, and the like. Merely by way of example, the network 910 can be a local area network (“LAN”), including without limitation an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth™ protocol known in the art, and/or any other wireless protocol; and/or any combination of these and/or other networks.

Embodiments of the invention can include one or more server computers 915. Each of the server computers 915 may be configured with an operating system, including without limitation any of those discussed above, as well as any commercially (or freely) available server operating systems. Each of the servers 915 may also be running one or more applications, which can be configured to provide services to one or more clients 905 and/or other servers 915.

Merely by way of example, one of the servers 915 may be a web server, which can be used, merely by way of example, to process requests for web pages or other electronic documents from user computers 905. The web server can also run a variety of server applications, including HTTP servers, FTP servers, CGI servers, database servers, Java™ servers, and the like. In some embodiments of the invention, the web server may be configured to serve web pages that can be operated within a web browser on one or more of the user computers 905 to perform methods of the invention.

The server computers 915, in some embodiments, might include one or more application servers, which can include one or more applications accessible by a client running on one or more of the client computers 905 and/or other servers 915. Merely by way of example, the server(s) 915 can be one or more general purpose computers capable of executing programs or scripts in response to the user computers 905 and/or other servers 915, including without limitation web applications (which might, in some cases, be configured to perform methods of the invention). Merely by way of example, a web application can be implemented as one or more scripts or programs written in any suitable programming language, such as Java™, C, C#™ or C++, and/or any scripting language, such as Perl, Python, or TCL, as well as combinations of any programming/scripting languages. The application server(s) can also include database servers, including without limitation those commercially available from Oracle®, Microsoft®, Sybase™, IBM™ and the like, which can process requests from clients (including, depending on the configuration, database clients, API clients, web browsers, etc.) running on a user computer 905 and/or another server 915. In some embodiments, an application server can create web pages dynamically for displaying the information in accordance with embodiments of the invention, such as the web pages described above. Data provided by an application server may be formatted as web pages (comprising HTML, Javascript™, etc., for example) and/or may be forwarded to a user computer 905 via a web server (as described above, for example). Similarly, a web server might receive web page requests and/or input data from a user computer 905 and/or forward the web page requests and/or input data to an application server. In some cases, a web server may be integrated with an application server.

In accordance with further embodiments, one or more servers 915 can function as a file server and/or can include one or more of the files (e.g., application code, data files, etc.) necessary to implement methods of the invention incorporated by an application running on a user computer 905 and/or another server 915. Alternatively, as those skilled in the art will appreciate, a file server can include all necessary files, allowing such an application to be invoked remotely by a user computer 905 and/or server 915. It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 920. The location of the database(s) 920 is discretionary: merely by way of example, a database 920a might reside on a storage medium local to (and/or resident in) a server 915a (and/or a user computer 905). Alternatively, a database 920b can be remote from any or all of the computers 905, 915, so long as the database 920b can be in communication (e.g., via the network 910) with one or more of these. In a particular set of embodiments, a database 920 can reside in a storage-area network (“SAN”) familiar to those skilled in the art. (Likewise, any necessary files for performing the functions attributed to the computers 905, 915 can be stored locally on the respective computer and/or remotely, as appropriate.) In one set of embodiments, the database(s) 920 can be relational databases, such as Oracle® databases, that are adapted to store, update, and retrieve data in response to SQL-formatted commands. The databases 920 might be controlled and/or maintained by a database server, as described above, for example.

While the invention has been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods of the invention are not limited to any particular structural and/or functional architecture but instead can be implemented on any suitable hardware, firmware and/or software configuration. Similarly, while various functionality is ascribed to certain system components, unless the context dictates otherwise, this functionality can be distributed among various other system components in accordance with different embodiments of the invention.

Moreover, while the procedures comprised in the methods and processes described herein are described in a particular order for ease of description, unless the context dictates otherwise, various procedures may be reordered, added, and/or omitted in accordance with various embodiments of the invention. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary features, the various components and/or features described herein with respect to a particular embodiment can be substituted, added and/or subtracted from among other described embodiments, unless the context dictates otherwise. Consequently, although the invention has been described with respect to exemplary embodiments, it will be appreciated that the invention is intended to cover all modifications and equivalents within the scope of the following claims.

What is claimed is:

1. A product trading exchange system, comprising:
a processor;
a computer-readable medium in communication with the processor, the computer-readable medium having encoded thereon a set of instructions executable by the processor to perform a method, the set of instructions comprising:
instructions for receiving one or more shares associated with a product in an initial public offering;
instructions for determining a number of shares to be sold in the initial public offering;
instructions for determining a share price for the shares to be sold in the initial public offering;
instructions for receiving one or more requests to purchase one or more shares in the initial public offering for the share price;
instructions for determining if all the shares to be sold in the initial public offering have been sold; and
instructions for allowing the shares to trade on the product trading exchange system after the initial public offering for a price determined by activity on the product trading exchange system.

2. The system as defined in claim 1, wherein a product owner inputs the share price for the initial public offering and the number of shares to be sold in the initial public offering.

3. The system as defined in claim 1, wherein, after each sale, a determination is made as to whether a number of shares sold in the initial public offering equals the number of shares to be sold in the initial public offering.

4. The system as defined in claim 1, wherein determining the price by activity on the product trading exchange system comprises:
instructions for reading a formula associated with the shares; and
instructions for executing the formula to determine the price per share for the one or more shares traded on the product trading exchange system.

5. The system as defined in claim 4, wherein the price per share is determined by a last offer for purchase of a share.

6. The system as defined in claim 1, wherein instructions for receiving one or more shares comprises instructions for receiving information associated with the product that can be used for business intelligence.

7. The system as defined in claim 6, further comprising:
instructions for creating business intelligence, wherein the business intelligence is based on data input by the product owner; and
instructions for providing the business intelligence to the one or more users, wherein the one or more users may evaluate the product and a value of the one or more shares with the business intelligence.

8. The system as defined in claim 1, further comprising:
instructions for receiving revenue from the sale of the product;
instructions for determining a portion of the received revenue owned by the product owner;
instructions for determining one or more portions of the received revenue associated with each share;
instructions for determining one or more portions of the received revenue owned by one or more shareholders based on a number of shares owned by the shareholder;
instructions for providing the determined portion of received revenue to the product owner; and
instructions for providing, to each of the one or more shareholders, the determined portion of received revenue owned by the user.

9. A method of using a product exchange comprising:
receiving, at a share sell engine, an offer to sell one or more shares of a product;
receiving, at a share purchase engine, a request to purchase one or more shares of the product;
communicating the offer to purchase from the share purchase engine to the share sell engine;
associating the offer to purchase with the offer to sell, wherein associating comprises:
determining a price for the one or more shares; and
selling the one or more shares for the determined price.

10. The method as defined in claim 9, further comprising:
determining revenue per share for each of the one or more shares; and
providing a revenue payment to each of the one or more users that own one or more shares.

11. The method as defined in claim 10, wherein the revenue payment is equal to the revenue per share multiplied by the number of shares owned by the user.

12. The method as defined in claim 9, further comprising matching a first offer to purchase one or more shares with a first one or more shares offered for sale.

13. The method as defined in claim 9, further comprising:
creating an account for each of the one or more users;
providing, in the account, the number of shares owned for the user;
providing, in the account, one or more monetary values for one or more shares owned by the user; and
providing, in the account, one or more monetary values for a projected revenue for one or more shares owned by the user.

14. The method as defined in claim 9, further comprising:
collecting one or more items of information from the product owner to create a business intelligence report; and
publishing the business intelligence report to the one or more users, wherein the business intelligence report provides a reporting of revenue to share owners.

15. A product stock exchange, comprising:
a network, the network operable to communicate data;
a product owner server in communication with the network, the product owner server operable to provide a first user interface for a product owner to upload one or more shares for an initial public offering associated with a product to the product owner server, to upload a number of shares to be offered in the initial public offering, and to upload a price per share for the initial public offering, the product owner server operable to offer the one or more shares associated in the initial public offering; and
a user server in communication with the network, the user server operable to provide a user interface to the user to purchase one or more shares in the initial public offering, the user server operable to receive an offer to purchase the one or more shares, the user server operable to receive payment for the one or more shares, and the user server operable to provide the one or more shares to the user.

16. The product stock exchange as defined in claim 15, further comprising a banking server in communication with the network, the banking server operable to receive the payment from the user server, the banking server operable to determine a first portion of revenue owned by the product owner and a second portion of revenue owned by one or more shareholders, the banking server operable to distribute the first portion to the product owner and distribute one or more second portions to one or more shareholders.

17. The product stock exchange as defined in claim 15, wherein the product owner server comprises an initial public offering engine, the initial public offering engine operable to receive the one or more shares for the initial public offering, to receive the number of shares to be offered in the initial public offering, and to receive the price per share for the initial public offering, the initial public offering engine operable to determine when the initial public offering has ended, the initial public offering engine operable to send a communication to a share purchase engine and a share sell engine to trade the one or more shares on the product stock exchange.

18. The product stock exchange as defined in claim 17, wherein the initial public offering engine is operable to compare a number of shares sold during the initial public offering to the number of shares received for the initial public offering and operable to stop the initial public offering if the number of shares sold equals the number of shares received.

19. The product stock exchange as defined in claim 15, wherein the user server comprises a share purchase engine, the share purchase engine operable to receive one or more requests to purchase one or more shares, the share purchase engine operable to generate a share purchase web page to allow a user to purchase one or more shares.

20. The product stock exchange as defined in claim 19, wherein the user server comprises a share sell engine, the share sell engine operable to receive one or more offers to sell one or more shares, the share sell engine operable to generate a share sell web page to allow a user to sell one or more shares, the share sell engine operable to receive the request to purchase from the share purchase engine and associate the request with an offer to sell.
